(19) United States
(12) Patent Application Publication
(10) Pub. No.: US 2021/0097864 A1
(43) Pub. Date: Apr. 1, 2021

(54) VEHICLE-MOUNTED TERMINAL-BASED TRAFFIC ACCIDENT JUDGEMENT METHOD AND SYSTEM

(71) Applicant: BOE TECHNOLOGY GROUP CO., LTD., Beijing (CN)

(72) Inventors: Zhenyan ZHAO, Beijing (CN); Yunpeng WU, Beijing (CN); Xiangxiang ZOU, Beijing (CN)

(21) Appl. No.: 16/835,675

(22) Filed: Mar. 31, 2020

(30) Foreign Application Priority Data
Sep. 26, 2019 (CN) 201910918259.7

(51) Int. Cl. G08G 1/16; B60W 60/00; B60W 30/095

(52) U.S. Cl. CPC G08G 1/162; B60W 30/0956; B60W 60/00272; G08G 1/166

(57) ABSTRACT

The present disclosure provides a vehicle-mounted terminal-based traffic accident judgement method and system. The vehicle-mounted terminal-based traffic accident judgement method includes: transmitting an early-warning signal; judging whether a cancellation warning signal is received within a first preset time period; when no cancellation warning signal is received within the first preset time period, obtaining third-party information; judging whether in safe state according to the third-party information; transmitting a warning signal to a traffic accident monitoring server when in unsafe state.

### CROSS-REFERENCE TO RELATED APPLICATION

This application claims the benefit and priority of Chinese Application No. 201910918259.7, filed on Sep. 26, 2019, which is incorporated herein by reference in its entirety.

### TECHNICAL FIELD

The present disclosure relates to the field of vehicle information technology, and in particular to a vehicle-mounted terminal-based traffic accident judgement method and system.

### BACKGROUND

At present, travel is now the main way of leisure for families. Self-driving travel has become a popular travel option, and highway driving has become the norm. Thus, it is particularly important to judge the traffic accident when driving.

In the related art, whether the vehicle has an accident is usually determined by comparing an acceleration value when braking with a preset acceleration value, and then an alarm is given. However, this method is too simple, and false alarms often occur.

Therefore, how to improve the accuracy of traffic accident alarms and reduce the false alarm rate has become an urgent problem to be solved.

### SUMMARY

One embodiment of the present disclosure provides a vehicle-mounted terminal-based traffic accident judgement method, including: transmitting an early-warning signal; judging whether a cancellation warning signal is received within a first preset time period; when no cancellation warning signal is received within the first preset time period, obtaining third-party information; judging whether in safe state according to the third-party information; transmitting a warning signal to a traffic accident monitoring server when in unsafe state.

In one embodiment, the obtaining third-party information and judging whether in safe state according to the third-party information, includes: receiving vehicle malfunction information of a vehicle transmitted by a vehicle-mounted automatic diagnosis device; and judging whether the vehicle is in safe state according to the vehicle malfunction information.

In one embodiment, after judging whether the vehicle is in safe state according to the vehicle malfunction information, the obtaining third-party information and judging whether in safe state according to the third-party information, further includes: when the vehicle is in safe state, obtaining face information of a driver; judging whether the driver is in safe state according to the face information of the driver.

In one embodiment, before the transmitting an early-warning signal, the method further includes: obtaining a current acceleration value of a vehicle; judging whether the current acceleration value of the vehicle is greater than a preset acceleration value; when the current acceleration value of the vehicle is greater than the preset acceleration value, issuing an alarm and transmitting the early-warning signal.

In one embodiment, before the obtaining a current acceleration value of a vehicle, the method further includes: obtaining current position information of the vehicle; transmitting the current position information of the vehicle to the traffic accident monitoring server; receiving traffic information transmitted by the traffic accident monitoring server, and determining an acceleration fluctuation value according to the traffic information; obtaining a current speed of the vehicle, and determining an acceleration threshold value according to the current speed of the vehicle; obtaining the preset acceleration value according to the acceleration fluctuation value and the acceleration threshold value.

In one embodiment, the judging whether the driver is in safe state according to the face information of the driver, includes: judging whether face information of the driver is obtained within a second preset time period; when the face information of the driver is obtained within the second preset time period, judging whether the face information of the driver is identical to preset driver face information.

In one embodiment, the first preset time period is 5 minutes, and the second preset time period is 1 minute.

In one embodiment, the transmitting a warning signal to a traffic accident monitoring server, includes: transmitting accident information and emergency contact information to the traffic accident monitoring server; wherein the accident information includes accident position information, vehicle speed at the time of the accident, acceleration value at the time of the accident, time of the accident and safety status of driver.

One embodiment of the present disclosure further provides a vehicle-mounted terminal including: a third-party information obtaining device; a communication device; and a control device. The communication device and the third-party information obtaining device are coupled with the control device, respectively. The communication device is configured to transmit an early-warning signal and receive a cancellation warning signal. The control device is configured to, when no cancellation warning signal is received by the communication device within a first preset time period, control the third-party information obtaining device to receive third-party information and judge whether in safe state according to the third-party information. The communication device is further configured to, when in unsafe state, transmit a warning signal to a traffic accident monitoring server.

In one embodiment, the third-party information obtaining device includes: a vehicle information obtaining device coupled with a vehicle-mounted automatic diagnostic device. The vehicle information obtaining device is configured to receive vehicle malfunction information of a vehicle transmitted by the vehicle-mounted automatic diagnosis device. The vehicle information obtaining device is coupled with the control device; the vehicle information obtaining device transmits the vehicle malfunction information to the control device; the control device judges whether the vehicle is in safe state according to the vehicle malfunction information; when the vehicle is in unsafe state, the communication device transmits the warning signal to the traffic accident monitoring server.

In one embodiment, the third-party information obtaining device further includes: a camera device configured to obtain face information of a driver. The camera device is coupled with the control device; the camera device transmits the face information of the driver to the control device; the control device judges whether the driver is in safe state according to the face information of the driver; when the driver is in unsafe state, the communication device transmits the warning signal to the traffic accident monitoring server.

In one embodiment, the vehicle-mounted terminal further includes: an acceleration obtaining device coupled with the control device and configured to obtain a current acceleration value of a vehicle; an alarm device coupled with the control device and configured to issue an alarm. The acceleration obtaining device transmits the current acceleration value of the vehicle to the control device; the control device compares the current acceleration value of the vehicle with a preset acceleration value; when the current acceleration value of the vehicle is greater than the preset acceleration value, the control device controls the alarm device to issue an alarm, and controls the communication device to transmit the early-warning signal to the traffic accident monitoring server.

In one embodiment, the vehicle-mounted terminal further includes: a position obtaining device coupled with the control device and configured to obtain current position information of the vehicle; a speed obtaining device coupled with the control device and configured to obtain a current speed of the vehicle. The position obtaining device transmits the current position information of the vehicle to the control device; the control device transmits the current position information of the vehicle to the traffic accident monitoring server through the communication device; the control device receives traffic information transmitted by the traffic accident monitoring server through the communication device; the control device determines an acceleration fluctuation value according to the traffic information; the speed obtaining device transmits the current speed of the vehicle to the control device; the control device is further configured to determine an acceleration threshold value according to the current speed of the vehicle, and determine the preset acceleration value according to the acceleration fluctuation value and the acceleration threshold value.

In one embodiment, the vehicle-mounted terminal further includes: a cancellation alarm device coupled with the control device and configured to receive the cancellation warning signal and transmit the cancellation warning signal to the control device; the control device cancels the warning signal according to the cancellation warning signal.

In one embodiment, the camera device includes: a rotator connected with the control device; a camera component fixedly connected to the rotator. The control device transmits a rotation signal to the rotator; the rotator rotates according to the rotation signal to adjust position of the camera component until the camera component captures face information of the driver; the camera component transmits the face information of the driver to the control device; the control device detects the face information of the driver.

In one embodiment, the vehicle-mounted terminal is a driving recorder.

One embodiment of the present disclosure further provides a traffic accident judgement system including: a vehicle-mounted terminal;

a traffic accident monitoring server coupled with the vehicle-mounted terminal; a vehicle-mounted automatic diagnosis device coupled with the vehicle-mounted terminal. The vehicle-mounted terminal includes: a third-party information obtaining device, a communication device and a control device; the communication device and the third-party information obtaining device are coupled with the control device, respectively. The communication device is configured to transmit an early-warning signal and receive a cancellation warning signal. The control device is configured to, when no cancellation warning signal is received by the communication device within a first preset time period, control the third-party information obtaining device to receive third-party information and judge whether in safe state according to the third-party information. The communication device is further configured to, when in unsafe state, transmit a warning signal to the traffic accident monitoring server.

In one embodiment, the vehicle-mounted terminal is a driving recorder.

One embodiment of the present disclosure further provides a computer device, including: a memory; and one or more processors. The memory is coupled with the processor, and the processor is configured to execute program instructions stored in the memory; the program instructions are executed to implement the above vehicle-mounted terminal-based traffic accident judgement method.

One embodiment of the present disclosure further provides a storage medium, including a stored program; wherein the program is executed to control a device where the storage medium is located to implement the above vehicle-mounted terminal-based traffic accident judgement method.

The above description is only an overview of the technical solution of the present disclosure. In order to understand the technical solution of the present disclosure more clearly, it can be implemented in accordance with the content of the description. In order to make the above and other objects, features and advantages of the present disclosure more comprehensible, specific embodiments of the present disclosure are given below.

### BRIEF DESCRIPTION OF THE DRAWINGS

In order to illustrate technical solutions according to embodiments of the present disclosure or in the related art more clearly, drawings to be used in the description of the embodiments or in the related art will be described briefly hereinafter. Apparently, the drawings described hereinafter are only some embodiments of the present disclosure, and other drawings may be obtained by those skilled in the art according to those drawings without creative work.

FIG. 1 is a flowchart of a vehicle-mounted terminal-based traffic accident judgement method according to an embodiment of the present disclosure;

FIG. 2 is a flowchart of a vehicle-mounted terminal-based traffic accident judgement method according to another embodiment of the present disclosure;

FIG. 3 is a schematic diagram of a vehicle-mounted terminal according to an embodiment of the present disclosure; and

FIG. 4 is a schematic diagram of a vehicle-mounted terminal according to another embodiment of the present disclosure.

Reference numbers

| | |
|---|---|
| vehicle-mounted terminal 1 | alarm lamp 12 |
| horizontal rotation axis 14 | vertical rotation axis 16 |
| mirror-display rearview mirror 18 | first cancellation alarm button 19 |
| second cancellation alarm button 20 | camera 22 |

### DETAILED DESCRIPTION

The technical solution of the present disclosure will be described hereinafter in a clear and complete manner in conjunction with the drawings and embodiments. Obviously, the following embodiments are merely a part of, rather than all of, the embodiments of the present disclosure, and based on these embodiments, a person skilled in the art may obtain the other embodiments, which also fall within the scope of the present disclosure.

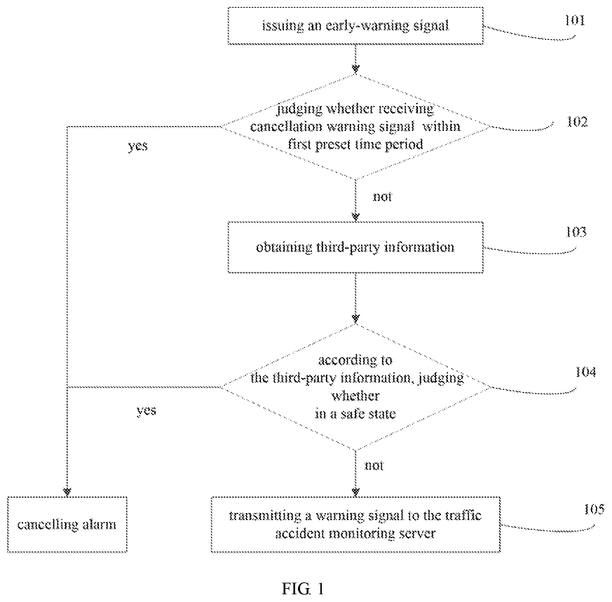

As shown in FIG. 1, one embodiment of the present disclosure provides a vehicle-mounted terminal-based traffic accident judgement method, including the following steps.

Step 101: transmitting an early-warning signal.

In this step, the vehicle-mounted terminal first makes a preliminary judgement on vehicle accident information. When the preliminary judgement is that there is danger, the vehicle-mounted terminal issues the early-warning signal. Meanwhile, the vehicle-mounted terminal transmits the early-warning signal to a traffic accident monitoring server, and gives an alarm to the outside.

Step 102: judging whether a cancellation warning signal is received within a first preset time period;

After receiving the early-warning signal transmitted by the vehicle-mounted terminal, the traffic accident monitoring server transmits the cancellation warning signal to the vehicle-mounted terminal. Within the first preset time period, when the vehicle-mounted terminal receives the cancellation warning signal transmitted by the traffic accident monitoring server or receives a cancellation warning signal transmitted by the vehicle-mounted terminal itself, it proves that the danger preliminarily judged by the vehicle-mounted terminal is within a controllable range of a user, and there is no real accident. Then, the vehicle-mounted terminal cancels the alarm and re-enters a driving operation process. Optionally, the traffic accident monitoring server is in communication with an electronic device, and the user can send a cancellation warning signal through the electronic device within the first preset time period. Then, the cancellation warning signal is transmitted to the vehicle-mounted terminal by the traffic accident monitoring server. The electronic device may be a mobile phone, a tablet computer or a smart watch. Optionally, a corresponding app may be installed in the electronic device to manage traffic accidents. The functions of the app include but not limited to: cancelling warning signals, uploading continuing alarm instructions, displaying and saving alarm information and recording.

Step 103: when no cancellation warning signal is received within the first preset time period, obtaining third-party information;

When the vehicle-mounted terminal receives no cancellation warning signal within the first preset time period, it indicates that the user who drives or rides cannot perform manual operations. At this time, it is further judged that the user in the vehicle may be in a danger state, thereby further obtaining the third-party information to judge the traffic accident.

Step 104: according to the third-party information, judging whether in a safe state.

Step 105: when in unsafe state, transmitting a warning signal to the traffic accident monitoring server.

When a driver is in the danger state, the warning signal is transmitted to the traffic accident monitoring server. The transmitting a warning signal to the traffic accident monitoring server includes: transmitting accident information and emergency contact information to the traffic accident monitoring server. The accident information includes accident position information, vehicle speed at the time of the accident, acceleration value at the time of the accident, time of the accident and safety status of driver. The emergency contact information includes name and phone number of emergency contact. After receiving the warning signal, the traffic accident monitoring server automatically transmits an alarm to the public security and traffic police departments, and transmits the accident information to the public security and traffic police departments as well as the emergency contact.

In the vehicle-mounted terminal-based traffic accident judgement method according to one embodiment of the present disclosure, after the vehicle-mounted terminal makes the preliminary judgement on the vehicle accident, the vehicle-mounted terminal transmits the early-warning signal. When the cancellation warning signal is received within the first preset time period, the vehicle-mounted terminal cancels the warning signal. When the cancellation warning signal transmitted by the traffic accident monitoring server is not received within the first preset time period, i.e., the user who drives or rides cannot perform manual operations, then it is judged that the user in the vehicle may be in a danger state. At this point, the vehicle-mounted terminal obtains the third-party information and judges whether in a safe state according to the third-party information. When in a safe state, the warning signal from the vehicle-mounted terminal is cancelled. When the driver is in the danger state, the warning signal is transmitted to the traffic accident monitoring server. According to the warning signal, the traffic accident monitoring server automatically transmits an alarm to the public security and traffic police departments. In this way, only when the cancellation warning signal manually transmitted by the user is not received as well as when it is automatically judged that the vehicle is in an unsafe state according to third-party information, the traffic accident alarm will occur. Thus, in the present disclosure, vehicle accident detection is performed by two technical means including user's manual operation and automatic judgement, which can improve the accuracy of the traffic accident alarm and reduce the false alarm rate of the traffic accident as compared with the related art.

In order to make a more detailed description of the above embodiment, one embodiment of the present disclosure further provides another vehicle-mounted terminal-based traffic accident judgement method. After no cancellation warning signal is received from the traffic accident monitoring server within the first preset time period, and before obtaining face information of the driver, the method further includes receiving vehicle malfunction information transmitted by a vehicle-mounted automatic diagnosis device, and judging whether the vehicle has a malfunction according to the vehicle malfunction information. In this way, the vehicle-mounted terminal makes an accurate judgement on vehicle accident. For this, one embodiment of the present disclosure provides the following specific steps. Specifically, according to the third-party information, judging whether in a safe state, includes:

Step 201: receiving vehicle malfunction information transmitted by a vehicle-mounted automatic diagnosis device.

Step 202: judging whether the vehicle is in a safe state according to the vehicle malfunction information.

When the vehicle-mounted terminal does not receive the cancellation warning signal transmitted by the traffic accident monitoring server within the first preset time period, the vehicle-mounted terminal is coupled with the vehicle-mounted automatic diagnosis device. The vehicle-mounted automatic diagnosis device transmits the vehicle malfunction information to the vehicle-mounted terminal. The vehicle-mounted terminal receives the vehicle malfunction information transmitted by the vehicle-mounted automatic diagnosis device, and judges whether the vehicle is in the safe state according to the vehicle malfunction information.

Step 203: when the vehicle is in the safe state, obtaining face information of the driver.

When the vehicle has a malfunction and is in unsafe state, the vehicle-mounted terminal transmits the warning signal to the traffic accident monitoring server. After receiving the warning signal, the traffic accident monitoring server automatically transmits an alarm to the public security and traffic police departments. When the vehicle has no malfunction and is in the safe state, the face information of the driver is obtained and then judgement on the traffic accident is performed according to the face information of the driver.

Step 204: according to the face information of the driver, judging whether the driver is in a safe state.

In this embodiment, when the cancellation warning signal transmitted by the traffic accident monitoring server is not received within the first preset time period, i.e., the user who drives or rides cannot perform manual operations, then it is judged that the user in the vehicle may be in a danger state. At this point, it is first judged whether the vehicle is in a safe state according to the third-party information. The third-party information includes vehicle malfunction information and the face information of the driver. The vehicle-mounted terminal obtains the vehicle malfunction information, and transmits the warning signal to the traffic accident monitoring server when it is judged that the vehicle is in unsafe state. When the vehicle is in the safe state, the vehicle-mounted terminal obtains the face information of the driver and judges whether the driver is in the safe state according to the face information of the driver. When the driver is in unsafe state, the vehicle-mounted terminal transmits the warning signal to the traffic accident monitoring server. According to the warning signal, the traffic accident monitoring server transmits an alarm. When the vehicle has a malfunction, it will inevitably lead to a traffic accident. Therefore, in the present disclosure, after judging the traffic accident by the user's manual operation, further detection is carried out according to the vehicle malfunction information and the face information of the driver, so as to accurately judge the traffic accident, thereby improving the accuracy of the traffic accident alarm and reducing the false alarm rate of the traffic accident as compared with the related art.

Optionally, the third-party information includes but not limited to, vehicle malfunction information and the face information of the driver. Other information capable of judging traffic accident may also be used as third-party information.

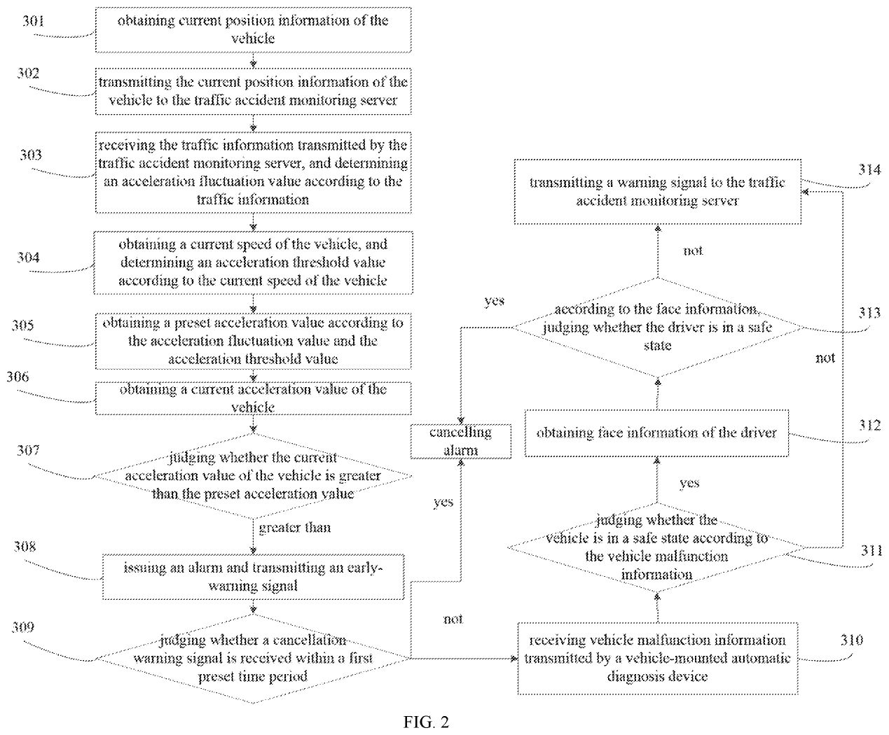

In order to make a more detailed description of the above embodiment, one embodiment of the present disclosure further provides another vehicle-mounted terminal-based traffic accident judgement method. As shown in FIG. 2, before issuing the early-warning signal and transmitting the early-warning signal to the traffic accident monitoring server, the method further includes: obtaining a current acceleration value of the vehicle; comparing the current acceleration value of the vehicle with a preset acceleration value. When it is judged that the current acceleration value of the vehicle is greater than the preset acceleration value, the early-warning signal is issued and transmitted to the traffic accident monitoring server, i.e., the vehicle-mounted terminal first makes a preliminary judgement on vehicle accident information. The preset acceleration value includes an acceleration fluctuation value and an acceleration threshold value. The preset acceleration value determined by the acceleration fluctuation value and the acceleration threshold value can accurately express the maximum acceleration of the vehicle, thereby preventing misjudgment of vehicle accident caused by inaccurate preset acceleration value. Specifically, this embodiment of the present disclosure includes the following steps.

Step 301: obtaining current position information of the vehicle.

Step 302: transmitting the current position information of the vehicle to the traffic accident monitoring server.

The vehicle-mounted terminal transmits the current position information of the vehicle to the traffic accident monitoring server. According to the current position information of the vehicle, the traffic accident monitoring server finds traffic information such as weather, temperature and humidity at the current position and whether the current position is a high-accident road section, and transmits the traffic information to the vehicle-mounted terminal.

Step 303: receiving the traffic information transmitted by the traffic accident monitoring server, and determining an acceleration fluctuation value according to the traffic information.

The vehicle-mounted terminal receives the traffic information such as weather, temperature and humidity at the current position and whether the current position is a high-accident road section, which is transmitted by the traffic accident monitoring server. Then, the vehicle-mounted terminal comprehensively calculates the acceleration fluctuation value based on the weather information. The acceleration fluctuation value can be finely adjusted according to whether the current position is a high-accident road section. Optionally, when there is heavy rain, fog, snow and ice in the area where the vehicle is located, the acceleration fluctuation value should be appropriately reduced to −0.05 g, where g is the gravitational acceleration, and g=9.80665 m/s². When the temperature of the area where the vehicle is located is too high or too low but there is no severe weather, the acceleration fluctuation value should be appropriately reduced to −0.025 g. When the weather is good and visibility is high in the area where the vehicle is located, the acceleration fluctuation value should be appropriately increased to 0.025 g. When the area where the vehicle is located is a high-accident road section, the acceleration fluctuation value should be appropriately reduced to −0.025 g. The acceleration fluctuation value may also be adjusted and revised according to actual situations.

Step 304: obtaining a current speed of the vehicle, and determining an acceleration threshold value according to the current speed of the vehicle.

When the vehicle speed is less than or equal to 60 km/h, the acceleration threshold value is 0.65 g. When the vehicle speed is greater than 60 km/h, the acceleration threshold value should be reduced in a linearly decreasing manner. When the vehicle speed reaches 120 km/h, the acceleration threshold value should be 0.5 g. When the vehicle speed exceeds 120 km/h, the acceleration threshold value is not reduced.

Step 305: obtaining a preset acceleration value according to the acceleration fluctuation value and the acceleration threshold value.

The sum of the acceleration fluctuation value and the acceleration threshold value is the preset acceleration value. Generally, an acceleration of the vehicle during emergency braking is between 0.6 g-0.8 g, where g is the gravitational acceleration, and g=9.80665 m/s². Therefore, when the acceleration value of the vehicle-mounted terminal is greater than 0.8 g, it can be judged that the vehicle has an abnormality or even other more dangerous accidents.

Step 306: obtaining a current acceleration value of the vehicle.

Step 307: judging whether the current acceleration value of the vehicle is greater than the preset acceleration value.

Step 308: when the current acceleration value of the vehicle is greater than the preset acceleration value, issuing an alarm and transmitting an early-warning signal.

When the current acceleration value of the vehicle is greater than the preset acceleration value, the vehicle-mounted terminal issues an alarm. Issuing the alarm includes that the vehicle-mounted terminal turns on an alarm lamp and a mirror-display rearview mirror displays alarm content. The alarm content includes an alarm call, name and phone number of emergency contact. Then, when nearby persons see the content of the rearview mirror, they can help to give an alarm. Meanwhile, the vehicle-mounted terminal transmits the early-warning signal to the traffic accident monitoring server.

Step 309: judging whether a cancellation warning signal is received within a first preset time period.

Step 310: when no cancellation warning signal is received within the first preset time period, receiving vehicle malfunction information transmitted by a vehicle-mounted automatic diagnosis device.

When the vehicle-mounted terminal does not receive the cancellation warning signal transmitted by the traffic accident monitoring server within the first preset time period, the vehicle-mounted terminal is coupled with the vehicle-mounted automatic diagnosis device. The vehicle-mounted automatic diagnosis device transmits the vehicle malfunction information to the vehicle-mounted terminal. The vehicle-mounted terminal receives the vehicle malfunction information transmitted by the vehicle-mounted automatic diagnosis device, and judges whether the vehicle is in the safe state according to the vehicle malfunction information.

Step 311: judging whether the vehicle is in a safe state according to the vehicle malfunction information.

Step 312: when the vehicle is in the safe state, obtaining face information of the driver.

When the vehicle is in the safe state, it is judged whether the driving is safe from the aspects of the driver. When the vehicle is in unsafe state, it will inevitably lead to a traffic accident. Thus, when it is judged that the vehicle is in unsafe state, the vehicle-mounted terminal transmits the warning signal to the traffic accident monitoring server.

Step 313: according to the face information, judging whether the driver is in a safe state.

Step 314: when the driver is in unsafe state, transmitting a warning signal to the traffic accident monitoring server.

In the vehicle-mounted terminal-based traffic accident judgement method of this embodiment, before transmitting the early-warning signal to the traffic accident monitoring server, the current acceleration value of the vehicle is obtained, and the current acceleration value of the vehicle is compared with the preset acceleration value. When it is judged that the current acceleration value of the vehicle is greater than the preset acceleration value, an alarm is issued and the early-warning signal is transmitted to the traffic accident monitoring server, i.e., the vehicle-mounted terminal first makes a preliminary judgement on traffic accident. The preset acceleration value includes an acceleration fluctuation value and an acceleration threshold value. The preset acceleration value determined by the acceleration fluctuation value and the acceleration threshold value can accurately express the maximum acceleration of the vehicle, thereby preventing misjudgment of vehicle accident caused by inaccurate preset acceleration value. By finely adjusting the acceleration threshold value and the acceleration fluctuation value according to different situations, this embodiment of the present disclosure can better ensure the life safety of the driver and reduce the probability of missed detection.

The judging whether the driver is in a safe state according to the face information of the step 313 includes:

Step 3131: judging whether the face information of the driver appears within the second preset time period.

Step 3132: when the face information of the driver is obtained within the second preset time period, judging whether the face information of the driver is identical to preset driver face information.

After the face information of the driver is obtained, the face detection algorithm starts to operate. Whether the face information of the driver appears within the second preset time period is judged through the face detection algorithm. When the face information of the driver does not appear within the second preset time period, it is judged that the driver is in unsafe state. When the face information of the driver appears within the second preset time period, similarity between the face information of the driver and the preset driver face information is calculated by face matching algorithm and facial feature extraction. Whether the face information of the driver and the preset driver face information belong to the same person is judged by similarity score. When it is judged that the face information of the driver and the preset driver face information belong to different persons, then the driver is in unsafe state. When it is judged that the face information of the driver and the preset driver face information belong to the same person, safety state detection is performed on the face information of the driver through safety state detection algorithm. The safety state detection algorithm includes facial feature detection algorithm and bloodstain target extraction algorithm. The facial feature detection algorithm is used to detect whether the driver is in unsafe state such as eyes closed. The bloodstain target extraction algorithm is used to extract an image block of suspected bloodstains in the face and judge the possibility of the image block being bloodstains in combination with RGB image. When it is detected that eyes of the driver are closed and the driver has bloodstains, it is judged that the driver is in unsafe state. When it is not detected that eyes of the driver are closed or the driver has bloodstains, it is judged that the driver is in safe state and the alarm is cancelled.

Optionally, the user may set the preset driver face information in advance.

In one embodiment of the present disclosure, the acceleration refers to reverse acceleration when the vehicle is braking.

In one embodiment of the present disclosure, after transmitting the early-warning signal, the vehicle-mounted terminal-based traffic accident judgement method further includes: storing video image information. After transmitting the early-warning signal to the traffic accident monitoring server, the method further includes transmitting the video image information to the traffic accident monitoring server. The video image information includes image information and the face information of the driver while driving.

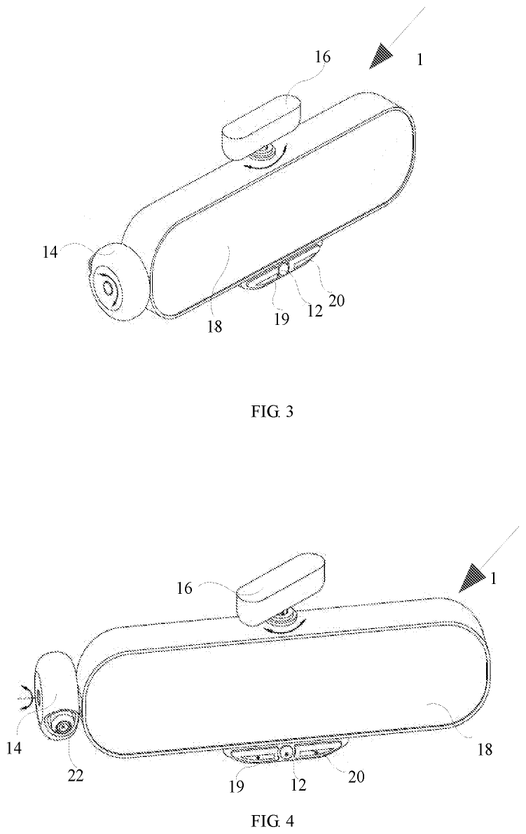

On the other hand, as shown in FIG. 3, one embodiment of the present disclosure further provides a vehicle-mounted terminal 1, including: a third-party information obtaining device, a communication device and a control device. The communication device and the third-party information obtaining device are coupled with the control device, respectively.

The communication device is configured to transmit an early-warning signal and receive a cancellation warning signal. The control device is configured to, when no cancellation warning signal is received by the communication device within a first preset time period, control the third-party information obtaining device to receive third-party information and judge whether in a safe state according to the third-party information. The communication device is further configured to, when in unsafe state, transmit a warning signal to the traffic accident monitoring server. In one embodiment, the control device may employ a processor.

The vehicle-mounted terminal 1 provided in one embodiment of the present disclosure includes: the third-party information obtaining device, the communication device and the control device. The vehicle-mounted terminal 1 first makes a preliminary judgement on vehicle accident information. When the preliminary judgement is that there is danger, the control device controls the communication device to issue the early-warning signal. After receiving the early-warning signal transmitted by the vehicle-mounted terminal 1, the traffic accident monitoring server transmits the cancellation warning signal to the vehicle-mounted terminal 1. When the vehicle-mounted terminal 1 receives the cancellation warning signal transmitted by the traffic accident monitoring server within the first preset time period, it proves that the danger preliminarily judged by the vehicle-mounted terminal 1 is within a controllable range of a user, and there is no real accident. Then, the control device cancels the alarm according to the cancellation warning signal. When the communication device receives no cancellation warning signal within the first preset time period, it indicates that the user who drives or rides cannot perform manual operations. At this time, it is further judged that the user in the vehicle may be in a danger state, and then the control device controls the third-party information obtaining device to obtain the third-party information. The third-party information obtaining device transmits the obtained third-party information to the control device. The control device judges whether the driving is in a safe state according to the third-party information. When in unsafe state, the control device control the communication device to transmit a warning signal to the traffic accident monitoring server. The transmitting a warning signal to the traffic accident monitoring server includes: transmitting accident information and emergency contact information to the traffic accident monitoring server. The accident information includes accident position information, vehicle speed at the time of the accident, acceleration value at the time of the accident, time of the accident and safety status of driver. After receiving the warning signal, the traffic accident monitoring server automatically transmits an alarm to the public security and traffic police departments, and transmits the accident information to the public security and traffic police departments.

In one embodiment of the present disclosure, the third-party information obtaining device includes a vehicle information obtaining device coupled with a vehicle-mounted automatic diagnostic device. The vehicle information obtaining device is configured to receive vehicle malfunction information transmitted by the vehicle-mounted automatic diagnosis device.

The vehicle information obtaining device is coupled with the control device. The vehicle information obtaining device transmits the vehicle malfunction information to the control device. The control device judges whether the vehicle is in safe state according to the vehicle malfunction information. When the vehicle is in unsafe state, the communication device transmits the warning signal to the traffic accident monitoring server. In one embodiment, the vehicle information obtaining device may employ a processor.

In this embodiment, the vehicle information obtaining device is coupled with the vehicle-mounted automatic diagnosis device through OBD socket in the vehicle-mounted terminal 1. When the communication device receives no cancellation warning signal transmitted by the traffic accident monitoring server within the first preset time period, it indicates that the user who drives or rides cannot perform manual operations. At this time, it is further judged whether the vehicle has a malfunction. The control device connects the vehicle-mounted terminal 1 with the vehicle-mounted automatic diagnosis device through the OBD socket. The vehicle information obtaining device receives vehicle malfunction information transmitted by the vehicle-mounted automatic diagnosis device. The vehicle information obtaining device is coupled with the control device, and transmits the received vehicle malfunction information to the control device. The control device judges whether the vehicle is in safe state according to the vehicle malfunction information. When judging that the vehicle has a malfunction and is in unsafe state, the communication device transmits the warning signal to the traffic accident monitoring server. The traffic accident monitoring server transmits an alarm to the public security and traffic police departments according to the warning signal.

In one embodiment of the present disclosure, the third-party information obtaining device further includes: a camera device for obtaining face information of a driver.

The camera device is coupled with the control device. The camera device transmits the face information of the driver to the control device. The control device judges whether the driver is in safe state according to the face information of the driver. When the driver is in unsafe state, the communication device transmits a warning signal to the traffic accident monitoring server.

In this embodiment, when the vehicle has no malfunction, the control device controls the camera device to capture face information of the driver. The camera device transmits the face information of the driver to the control device. The control device further judges whether the driver is in safe state according to the face information of the driver. When the driver is in safe state, the alarm is cancelled. When the driver is in unsafe state, a traffic accident occurs, and the communication device transmits the warning signal to the traffic accident monitoring server. Therefore, after the vehicle malfunction detection is performed, face recognition is further performed to further judge the traffic accident, and this the traffic accident can be accurately judged, thereby improving the accuracy of the traffic accident alarm and reducing the false alarm rate of the traffic accident as compared with the related art.

Optionally, after the camera device obtains the face information of the driver, the camera device transmits the face information of the driver to the control device. The control device judges whether the driver is in safe state according to the face information of the driver. One way for judging whether the driver is in safe state is as follows. The face detection algorithm starts to operate. Whether the face appears in the lens within the second preset time period is judged through the face detection algorithm. When the face information of the driver does not appear within the second preset time period, it is judged that the driver is in unsafe state. When the face information of the driver appears within the second preset time period, similarity between the face information of the driver and the preset driver face information is calculated by face matching algorithm and facial feature extraction. Whether the face information of the driver and the preset driver face information belong to the same person is judged by similarity score. When it is judged that the face information of the driver and the preset driver face information belong to different persons, then the driver is in unsafe state. When it is judged that the face information of the driver and the preset driver face information belong to the same person, safety state detection is performed on the face information of the driver through safety state detection algorithm. The safety state detection algorithm includes facial feature detection algorithm and bloodstain target extraction algorithm. The facial feature detection algorithm is used to detect whether the driver is in unsafe state such as eyes closed. The bloodstain target extraction algorithm is used to extract an image block of suspected bloodstains in the face and judge the possibility of the image block being bloodstains in combination with RGB image. When it is detected that eyes of the driver are closed and the driver has bloodstains, it is judged that the driver is in unsafe state. When it is not detected that eyes of the driver are closed or the driver has bloodstains, it is judged that the driver is in safe state and the alarm is cancelled.

Optionally, the communication device is a wireless communication device. The vehicle-mounted terminal 1 is wirelessly connected to the traffic accident monitoring server. The traffic accident monitoring server is in communication with an electronic device. The user can send a cancellation warning signal through the electronic device within the first preset time period. Then, the cancellation warning signal is transmitted to the vehicle-mounted terminal 1 by the traffic accident monitoring server. The electronic device may be a mobile phone, a tablet computer or a smart watch. Optionally, a corresponding app may be installed in the electronic device to manage traffic accidents. The functions of the app include but not limited to: cancelling warning signals, uploading continuing alarm instructions, displaying and saving alarm information and recording.

In one embodiment of the present disclosure, the vehicle-mounted terminal 1 further includes:

an acceleration obtaining device coupled with the control device and configured to obtain a current acceleration value of the vehicle;

an alarm device coupled with the control device for issuing an alarm.

The acceleration obtaining device transmits the current acceleration value of the vehicle to the control device. The control device compares the current acceleration value of the vehicle with a preset acceleration value. When the current acceleration value of the vehicle is greater than the preset acceleration value, the control device controls the alarm device to issue an alarm, and controls the communication device to transmit an early-warning signal to the traffic accident monitoring server.

In one embodiment, the acceleration obtaining device is an acceleration sensor for sensing and obtaining the current acceleration value of the vehicle. The acceleration sensor transmits the obtained current acceleration value to the control device. The control device compares the received current acceleration value with the preset acceleration value. When the current acceleration value of the vehicle is greater than the preset acceleration value, the control device controls the alarm device to issue an alarm, and controls the communication device to transmit an early-warning signal to the traffic accident monitoring server, thereby making a preliminary judgement on traffic accident information.

Optionally, the alarm device includes an alarm lamp 12 and a mirror-display rearview mirror 18. When the alarm device issues an alarm, the alarm lamp 12 is turned on to light. The mirror-display rearview mirror 18 displays alarm content. The alarm content includes an alarm call, name and phone number of emergency contact. Then, when nearby persons see the content of the mirror-display rearview mirror 18, they can help to give an alarm.

In one embodiment of the present disclosure, the vehicle-mounted terminal 1 further includes:

a position obtaining device coupled with the control device and configured to obtain current position information of the vehicle;

a speed obtaining device coupled with the control device and configured to obtain a current speed of the vehicle.

The position obtaining device transmits the current position information of the vehicle to the control device. The control device transmits the current position information of the vehicle to the traffic accident monitoring server through the communication device. The control device receives traffic information transmitted by the traffic accident monitoring server through the communication device. The control device determines an acceleration fluctuation value according to the traffic information. The speed obtaining device transmits the current speed of the vehicle to the control device. The control device is further configured to determine an acceleration threshold value according to the current speed of the vehicle, and determine the preset acceleration value according to the acceleration fluctuation value and the acceleration threshold value.

In one embodiment, the position obtaining device is a GPS, and the speed obtaining device is a speed sensor. The GPS obtains the current position information of the vehicle, and transmits the current position information of the vehicle to the control device. The control device transmits the current position information of the vehicle to the traffic accident monitoring server through the communication device. The traffic accident monitoring server finds traffic information such as weather, temperature and humidity at the current position and whether the current position is a high-accident road section, and transmits the traffic information to the control device through the communication device. The control device comprehensively calculates the acceleration fluctuation value based on the weather information, and finely adjusts the acceleration fluctuation value according to whether the current position is a high-accident road section, thereby determining the acceleration fluctuation value.

The speed obtaining device obtains the current speed of the vehicle and transmits the current speed of the vehicle to the control device. The control device determines the acceleration threshold value according to the current speed of the vehicle. Then, the control device obtains the preset acceleration value by adding the acceleration fluctuation value and the acceleration threshold value. The preset acceleration value may be determined according to current situation, thereby preventing misjudgment of vehicle accident caused by inaccurate preset acceleration value, and then better ensuring the life safety of the driver and reducing the probability of missed detection.

Optionally, when there is heavy rain, fog, snow and ice in the area where the vehicle is located, the acceleration fluctuation value should be appropriately reduced to −0.05 g, where g is the gravitational acceleration, and g=9.80665 m/s². When the temperature of the area where the vehicle is located is too high or too low but there is no severe weather, the acceleration fluctuation value should be appropriately reduced to −0.025 g. When the weather is good and visibility is high in the area where the vehicle is located, the acceleration fluctuation value should be appropriately increased to 0.025 g. When the area where the vehicle is located is a high-accident road section, the acceleration fluctuation value should be appropriately reduced to −0.025 g. The acceleration fluctuation value may also be adjusted and revised according to actual situations. When the vehicle speed is less than or equal to 60 km/h, the acceleration threshold value is 0.65 g. When the vehicle speed is greater than 60 km/h, the acceleration threshold value should be reduced in a linearly decreasing manner. When the vehicle speed reaches 120 km/h, the acceleration threshold value should be 0.5 g. When the vehicle speed exceeds 120 km/h, the acceleration threshold value is not reduced. The sum of the acceleration fluctuation value and the acceleration threshold value is the preset acceleration value. Generally, an acceleration of the vehicle during emergency braking is between 0.6 g-0.8 g, where g is the gravitational acceleration, and g=9.80665 m/s². Therefore, when the acceleration value of the vehicle-mounted terminal 1 is greater than 0.8 g, it can be judged that the vehicle has an abnormality or even other more dangerous accidents.

In one embodiment of the present disclosure, the vehicle-mounted terminal 1 further includes:

a cancellation alarm device coupled with the control device and configured to receive a cancellation warning signal and transmit the cancellation warning signal to the control device. The control device cancels the warning signal according to the cancellation warning signal.

In one embodiment, the vehicle-mounted terminal 1 further includes a cancellation alarm device. The cancellation alarm device includes a first cancellation alarm button 19 and a second cancellation alarm button 20 on the vehicle-mounted terminal 1. The first cancellation alarm button 19 is biased towards the driver. The second cancellation alarm button 20 is biased towards the co-pilot position, so that it is convenient for the co-pilot to press the cancellation alarm button when the driver is inconvenient, without blocking the driver from viewing the mirror-display rearview mirror 18. In this way, when the acceleration value is greater than the preset acceleration value and the control device issues an alarm, the cancellation alarm device on the vehicle-mounted terminal 1 can also cancel the warning signal. When the cancellation alarm device is operated within the first preset time period or the cancellation warning signal transmitted by the traffic accident monitoring server is received, the alarm is cancelled. Then, the alarm lamp 12 of the vehicle-mounted terminal 1 is turned off, the mirror-display rearview mirror 18 does not display the alarm content, and the vehicle-mounted terminal 1 re-enters a driving operation process. In this way, both of the vehicle-mounted terminal 1 and the traffic accident monitoring server can cancel the alarm, and the operation is more convenient.

In one embodiment of the present disclosure, the camera device includes:

a rotator connected with the control device;

a camera component fixedly connected to the rotator.

The control device transmits a rotation signal to the rotator. The rotator rotates according to the rotation signal to adjust the position of the camera component until the camera component captures the face information of the driver. The camera component transmits the face information of the driver to the control device. The control device detects the face information of the driver.

In this embodiment, the camera device includes the rotator and the camera component. The rotator is connected to the control device, and the camera component is fixedly connected to the rotator. The rotator includes a horizontal rotation axis 14 and a vertical rotation axis 16. The camera component is a camera 22. The camera 22 is fixed on the horizontal rotation axis 14 or the vertical rotation axis 16. As shown in FIG. 4, the camera 22 is fixed on the horizontal rotation axis, so that the rotation of the horizontal rotation axis 14 can drive the camera 22 to rotate in the horizontal direction. The rotation of the vertical rotation axis 16 drives the entire vehicle-mounted terminal 1 to rotate in the vertical direction. When the vehicle has no malfunction, the control device controls the rotator to rotate the camera 22 towards inside of the vehicle. The camera component starts to capture the face information of the driver. During the capturing process, the horizontal rotation axis 14 and the vertical rotation axis 16 can be finely adjusted to make the driver's face appear in the lens. When the driver's face is detected, the adjustment of the rotator is stopped to start safety state detection on the face information of the driver. When it is judged that the driver is in dangerous state, the control device controls the communication device to transmit a warning signal to the traffic accident monitoring server. When it is judged that the driver is in safe state, the control device controls the rotator to rotate the camera 22 to its original position. The alarm lamp 12 is turned off, the mirror-display rearview mirror 18 does not display the alarm content, and the vehicle-mounted terminal 1 re-enters a driving operation process.

Optionally, when the camera 22 is rotated towards the inside of the vehicle and starts to capture the face information of the driver, the face detection algorithm starts to operate. Whether the face appears in the lens is judged through the face detection algorithm. Optionally, the user sets the driver's face information in advance through preset settings. Similarity between the face information of the driver and the preset driver face information is calculated by face matching algorithm and facial feature extraction. Whether the face information of the driver and the preset driver face information belong to the same person is judged by similarity score. When the face information of the driver is detected within the second preset time period, safety state detection is performed on the driver through safety state detection algorithm. The safety state detection algorithm includes facial feature detection algorithm and bloodstain target extraction algorithm. The facial feature detection algorithm is used to detect whether the driver is in unsafe state such as eyes closed. The bloodstain target extraction algorithm is used to extract an image block of suspected bloodstains in the face and judge the possibility of the image block being bloodstains in combination with RGB image.

Optionally, the camera device further includes an infrared camera 22. The infrared camera 22 is used to improve the recognition success rate of bloodstain detection.

In one embodiment of the present disclosure, the control device is further configured to set in advance the first preset time period, and the name and phone number of the emergency contact. The camera device is further configured to set in advance a second preset time period and store in advance preset driver face information. Optionally, the first preset time period is 5 minutes, and the second preset time period is 1 minute.

In one embodiment of the present disclosure, a storage device is further included. The storage device is coupled with the control device, the camera device and the communication device, respectively. The storage device is used for storing video image information captured by the camera device.

After the control device controls the communication device to transmit the early-warning signal to the traffic accident monitoring server, the control device controls the storage device to transmit the video image information to the traffic accident monitoring server through the communication device. The video image information includes image information and the face information of the driver while driving.

In one embodiment of the present disclosure, the acceleration refers to reverse acceleration when the vehicle is braking.

According to another aspect, one embodiment of the present disclosure further includes a traffic accident judgement system. The traffic accident judgement system includes the above vehicle-mounted terminal, a traffic accident monitoring server and a vehicle-mounted automatic diagnosis device. The traffic accident monitoring server is coupled with the vehicle-mounted terminal. The vehicle-mounted automatic diagnosis device is coupled with the vehicle-mounted terminal.

In the traffic accident judgement system of one embodiment of the present disclosure,

after the vehicle-mounted terminal makes the preliminary judgement on the vehicle accident, the vehicle-mounted terminal transmits the early-warning signal. When the cancellation warning signal is received within the first preset time period, the vehicle-mounted terminal cancels the warning signal. When the cancellation warning signal transmitted by the traffic accident monitoring server is not received within the first preset time period, i.e., the user who drives or rides cannot perform manual operations, then it is judged that the user in the vehicle may be in a danger state. At this point, the vehicle-mounted terminal obtains the vehicle malfunction information. When the vehicle has no malfunction, the face information of the driver is obtained and whether the driver is in unsafe state is judged according to the face information of the driver. When the driver is in safe state, the warning signal from the vehicle-mounted terminal is cancelled. When the driver is in unsafe state, the warning signal is transmitted to the traffic accident monitoring server. According to the warning signal, the traffic accident monitoring server automatically transmits an alarm to the public security and traffic police departments. In this way, vehicle accidents is comprehensively judged by means of user's manual operation, judgment of vehicle malfunction and automatic judgment of face information of the driver, thereby improving the accuracy of the traffic accident alarm and reducing the false alarm rate of the traffic accident as compared with the related art.

According to another aspect, one embodiment of the present disclosure further provides a computer device including a memory and one or more processors. The memory is coupled to the processor. The processor is configured to execute program instructions stored in the memory. The program instructions are executed to implement the above vehicle-mounted terminal-based traffic accident judgement method.

According to another aspect, one embodiment of the present disclosure further provides a storage medium. The storage medium includes a stored program. The program is executed to control a device where the storage medium is located to implement the above vehicle-mounted terminal-based traffic accident judgement method.

The above memory may include a non-persistent memory, a random access memory (RAM) and/or non-volatile memory in a computer readable medium, such as read only memory (ROM) or flash memory. The memory includes at least one memory chip.

One embodiment of the present disclosure further provides a storage medium. The storage medium includes a stored program. The program is executed to control a device where the storage medium is located to implement the above vehicle-mounted terminal-based traffic accident judgement method.

The storage medium is a computer program product. When the computer program product is executed on a data processing device, the computer program product is suitable for implementing the above vehicle-mounted terminal-based traffic accident judgement method.

Those skilled in the art will appreciate that embodiments of the present disclosure may be provided as a method, system, or computer program product. Accordingly, the present disclosure may take the form of an entirely hardware embodiment, an entirely software embodiment, or a combination of software and hardware. Moreover, the present disclosure can take the form of a computer program product embodied on one or more computer-usable storage media (including but not limited to disk storage, CD-ROM, optical storage, etc.) including computer usable program codes.

The present disclosure has been described with reference to the flow charts and/or block diagrams of the method, device (system) and computer program product according to the embodiments of the present disclosure. It should be understood that computer program instructions may be used to implement each of the work flows and/or blocks in the flow charts and/or the block diagrams, and the combination of the work flows and/or blocks in the flow charts and/or the block diagrams. These computer program instructions may be provided to a processor of a common computer, a dedicate computer, an embedded processor or any other programmable data processing devices to create a machine, so that instructions executable by the processor of the computer or the other programmable data processing devices may create a device to achieve the functions assigned in one or more work flows in the flow chart and/or one or more blocks in the block diagram.

These computer program instructions may also be stored in a computer readable storage that may guide the computer or the other programmable data process devices to function in a certain way, so that the instructions stored in the computer readable storage may create a product including an instruction unit which achieves the functions assigned in one or more flows in the flow chart and/or one or more blocks in the block diagram.

These computer program instructions may also be loaded in the computer or the other programmable data process devices, so that a series of operation steps are executed on the computer or the other programmable devices to create processes achieved by the computer. Therefore, the instructions executed in the computer or the other programmable devices provide the steps for achieving the function assigned in one or more flows in the flow chart and/or one or more blocks in the block diagram.

In a typical configuration, a computing device includes one or more processors (CPUs), input/output interfaces, network interfaces, and a memory.

The memory may include a non-persistent memory, a random access memory (RAM) and/or non-volatile memory in a computer readable medium, such as read only memory (ROM) or flash memory. The memory is an example of a computer readable medium.

The computer readable media may be permanent and non-persistent, removable and non-removable media, which can store information by any method or technology. The information may be computer-readable instructions, data structures, modules of a program, or other data. Examples of the computer storage media include, but are not limited to, phase change memory (PRAM), static random access memory (SRAM), dynamic random access memory (DRAM), other types of random access memory (RAM), and read-only memory (ROM), electrically erasable programmable read-only memory (EEPROM), flash memory or other memory technology, read-only disc read-only memory (CD-ROM), digital versatile disc (DVD) or other optical storage, magnetic tape cartridges, magnetic tape magnetic disk storage or other magnetic storage devices or any other non-transmission media which may be used to store information that can be accessed by computing devices. As defined herein, the computer-readable media does not include computer-readable transitory media such as modulated data signals and carrier waves.

The above are only the specific embodiments of the present disclosure, but the protection scope of the present disclosure is not limited to these embodiments. Any technical personnel who is familiar with the technical field can easily think of changes or substitutions within the technical scope of the present disclosure and these changes and substitutions should be included in the protection scope of the present disclosure.

What is claimed is:

1. A vehicle-mounted terminal-based traffic accident judgement method, comprising:
transmitting an early-warning signal;
judging whether a cancellation warning signal is received within a first preset time period;
when no cancellation warning signal is received within the first preset time period, obtaining third-party information;
judging whether in safe state according to the third-party information;
transmitting a warning signal to a traffic accident monitoring server when in unsafe state.

2. The method according to claim 1, wherein the obtaining third-party information and judging whether in safe state according to the third-party information, includes:
receiving vehicle malfunction information of a vehicle transmitted by a vehicle-mounted automatic diagnosis device; and
judging whether the vehicle is in safe state according to the vehicle malfunction information.

3. The method according to claim 2, wherein after judging whether the vehicle is in safe state according to the vehicle malfunction information, the obtaining third-party information and judging whether in safe state according to the third-party information, further includes:
when the vehicle is in safe state, obtaining face information of a driver;
judging whether the driver is in safe state according to the face information of the driver.

4. The method according to claim 1, wherein before the transmitting an early-warning signal, the method further includes:
obtaining a current acceleration value of a vehicle;
judging whether the current acceleration value of the vehicle is greater than a preset acceleration value;
when the current acceleration value of the vehicle is greater than the preset acceleration value, issuing an alarm and transmitting the early-warning signal.

5. The method according to claim 4, wherein before the obtaining a current acceleration value of a vehicle, the method further includes:
obtaining current position information of the vehicle;
transmitting the current position information of the vehicle to the traffic accident monitoring server;
receiving traffic information transmitted by the traffic accident monitoring server, and determining an acceleration fluctuation value according to the traffic information;
obtaining a current speed of the vehicle, and determining an acceleration threshold value according to the current speed of the vehicle;
obtaining the preset acceleration value according to the acceleration fluctuation value and the acceleration threshold value.

6. The method according to claim 3, wherein the judging whether the driver is in safe state according to the face information of the driver, includes:
judging whether face information of the driver is obtained within a second preset time period;
when the face information of the driver is obtained within the second preset time period, judging whether the face information of the driver is identical to preset driver face information.

7. The method according to claim 6, wherein the first preset time period is 5 minutes, and the second preset time period is 1 minute.

8. The method according to claim 1, wherein the transmitting a warning signal to a traffic accident monitoring server, includes:
transmitting accident information and emergency contact information to the traffic accident monitoring server;
wherein the accident information includes accident position information, vehicle speed at the time of the accident, acceleration value at the time of the accident, time of the accident and safety status of driver.

9. A vehicle-mounted terminal comprising:
a third-party information obtaining device;
a communication device; and
a control device;
wherein the communication device and the third-party information obtaining device are coupled with the control device, respectively;
the communication device is configured to transmit an early-warning signal and receive a cancellation warning signal;
the control device is configured to, when no cancellation warning signal is received by the communication device within a first preset time period, control the third-party information obtaining device to receive third-party information and judge whether in safe state according to the third-party information;
the communication device is further configured to, when in unsafe state, transmit a warning signal to a traffic accident monitoring server.

10. The vehicle-mounted terminal according to claim 9, wherein the third-party information obtaining device includes:
a vehicle information obtaining device coupled with a vehicle-mounted automatic diagnostic device;
wherein the vehicle information obtaining device is configured to receive vehicle malfunction information of a vehicle transmitted by the vehicle-mounted automatic diagnosis device;
the vehicle information obtaining device is coupled with the control device; the vehicle information obtaining device transmits the vehicle malfunction information to the control device; the control device judges whether the vehicle is in safe state according to the vehicle malfunction information; when the vehicle is in unsafe state, the communication device transmits the warning signal to the traffic accident monitoring server.

11. The vehicle-mounted terminal according to claim 10, wherein the third-party information obtaining device further includes:
a camera device configured to obtain face information of a driver;
wherein the camera device is coupled with the control device; the camera device transmits the face information of the driver to the control device; the control device judges whether the driver is in safe state according to the face information of the driver; when the driver is in unsafe state, the communication device transmits the warning signal to the traffic accident monitoring server.

12. The vehicle-mounted terminal according to claim 9, further comprising:
an acceleration obtaining device coupled with the control device and configured to obtain a current acceleration value of a vehicle;
an alarm device coupled with the control device and configured to issue an alarm;
wherein the acceleration obtaining device transmits the current acceleration value of the vehicle to the control device; the control device compares the current acceleration value of the vehicle with a preset acceleration value; when the current acceleration value of the vehicle is greater than the preset acceleration value, the control device controls the alarm device to issue an alarm, and controls the communication device to transmit the early-warning signal to the traffic accident monitoring server.

13. The vehicle-mounted terminal according to claim 12, further comprising:
a position obtaining device coupled with the control device and configured to obtain current position information of the vehicle;
a speed obtaining device coupled with the control device and configured to obtain a current speed of the vehicle;
wherein the position obtaining device transmits the current position information of the vehicle to the control device; the control device transmits the current position information of the vehicle to the traffic accident monitoring server through the communication device; the control device receives traffic information transmitted by the traffic accident monitoring server through the communication device; the control device determines an acceleration fluctuation value according to the traffic information; the speed obtaining device transmits the current speed of the vehicle to the control device; the control device is further configured to determine an acceleration threshold value according to the current speed of the vehicle, and determine the preset acceleration value according to the acceleration fluctuation value and the acceleration threshold value.

14. The vehicle-mounted terminal according to claim 12, further comprising:
a cancellation alarm device coupled with the control device and configured to receive the cancellation warning signal and transmit the cancellation warning signal to the control device; the control device cancels the warning signal according to the cancellation warning signal.

15. The vehicle-mounted terminal according to claim 11, wherein the camera device includes:
a rotator connected with the control device;
a camera component fixedly connected to the rotator;
wherein the control device transmits a rotation signal to the rotator; the rotator rotates according to the rotation signal to adjust position of the camera component until the camera component captures face information of the driver; the camera component transmits the face information of the driver to the control device; the control device detects the face information of the driver.

16. The vehicle-mounted terminal according to claim 9, wherein the vehicle-mounted terminal is a driving recorder.

17. A traffic accident judgement system comprising:
a vehicle-mounted terminal;
a traffic accident monitoring server coupled with the vehicle-mounted terminal;
a vehicle-mounted automatic diagnosis device coupled with the vehicle-mounted terminal;
wherein the vehicle-mounted terminal includes: a third-party information obtaining device, a communication device and a control device; the communication device and the third-party information obtaining device are coupled with the control device, respectively;
the communication device is configured to transmit an early-warning signal and receive a cancellation warning signal;
the control device is configured to, when no cancellation warning signal is received by the communication device within a first preset time period, control the third-party information obtaining device to receive third-party information and judge whether in safe state according to the third-party information;
the communication device is further configured to, when in unsafe state, transmit a warning signal to the traffic accident monitoring server.

18. The system according to claim 17, wherein the vehicle-mounted terminal is a driving recorder.

19. A computer device, comprising:
a memory; and
one or more processors;
wherein the memory is coupled with the processor, and the processor is configured to execute program instructions stored in the memory; the program instructions are executed to implement the method according to claim 1.

20. A storage medium, comprising a stored program; wherein the program is executed to control a device where the storage medium is located to implement the method according to claim 1.
